(19) United States
(12) Patent Application Publication
(10) Pub. No.: US 2025/0080491 A1
(43) Pub. Date: Mar. 6, 2025

(54) EXCHANGING LOCAL ADDRESS INFORMATION FOR A MEDIA COMMUNICATION SESSION

(71) Applicant: QUALCOMM Incorporated, San Diego, CA (US)

(72) Inventors: Liangping Ma, San Diego, CA (US); Sebastian Speicher, Wallisellen (CH); Imed Bouazizi, Celina, TX (US); Dario Serafino Tonesi, San Diego, CA (US); Nikolai Konrad Leung, San Francisco, CA (US)

(21) Appl. No.: 18/819,619

(22) Filed: Aug. 29, 2024

Related U.S. Application Data
(60) Provisional application No. 63/580,250, filed on Sep. 1, 2023.

(51) Int. Cl. H04L 61/2514; H04L 12/46; H04L 61/5007; H04L 101/659

(52) U.S. Cl. CPC H04L 61/2514; H04L 12/4633; H04L 61/5007; H04L 2101/659

(57) ABSTRACT

A first client device may participate in a media communication session with a second client device. The first client device may receive a local IP address type of the second client device. The first client device may provide the local IP address type to an intermediate network device. In this manner, the intermediate network device may use the local IP address type to calculate a protocol data unit (PDU) set size (PSSize) based on the local IP address type. The intermediate network device may add the calculated PSSize value to a tunnel header of a tunnel packet that encapsulates a packet including media data sent by the second client device to the first client device. In this manner, other network devices may receive accurate values for the PSSize when media data is exchanged via network tunnels, to ensure that all packets of a common PDU set are delivered together.

This application claims the benefit of U.S. Provisional Application No. 63/580,250, filed Sep. 1, 2023, the entire contents of which are hereby incorporated by reference.

### TECHNICAL FIELD

This disclosure relates to storage and transport of encoded media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging media data via a network. In particular, two devices (e.g., two UEs, a UE and a non-cellular device (such as a desktop, laptop, tablet, peripheral such as a head-mounted display, or the like)) may engage in a media communication session. The media communication session may be related to extended reality (XR), such as augmented reality (AR), virtual reality (VR), mixed reality (MR), or the like. Media data exchanged as part of the media communication session may include audio, video, computer graphics, or other such data. The media data may be organized into protocol data units (PDUs), which may be grouped into PDU sets. In some cases, a PDU set size (PSSize) advertised in an RTP header by one of the two devices may be based on a local IP address type, which may differ from a global IP address type used to send the packet via a network tunnel. For example, the local IP address type may be an IPv4 address, whereas an IPv6 address may be used when performing tunneling. Thus, an intermediate network device may calculate an updated PSSize value based on the local IP address type and add the updated PSSize value to a tunnel header of a tunnel packet used to encapsulate a packet received from the client device. Other network devices may use the PSSize value to ensure that all packets of a common PDU set are delivered together.

In one example, a method of exchanging media data via a network includes: receiving, by an intermediate network device, data from a first client device representing a global Internet protocol (IP) address and a local IP address type for a second client device, the intermediate network device being between the first client device and the second client device; receiving, by the intermediate network device, a packet of a protocol data unit (PDU) set from the second client device destined for the first client device; extracting, by the intermediate network device, a PDU set size (PSSize) value from the packet; forming, by the intermediate network device, an adjusted PSSize value based on the local IP address type for the second client device; adding, by the intermediate network device, the adjusted PSSize value to a tunnel header of a tunneled packet that encapsulates the packet; and sending, by the intermediate network device, the tunneled packet to the first client device.

In another example, a network device for exchanging media data via a network includes a memory; and a processing system implemented in circuitry and in communication with the memory, the processing system being configured to: receive data from a first client device representing a global Internet protocol (IP) address and a local IP address type for a second client device, the network device being between the first client device and the second client device; receive a packet of a protocol data unit (PDU) set from the second client device destined for the first client device; extract a PDU set size (PSSize) value from the packet; form an adjusted PSSize value based on the local IP address type for the second client device; add the adjusted PSSize value to a tunnel header of a tunneled packet that encapsulates the packet; and send the tunneled packet to the first client device.

In another example, a method of exchanging media data via a network includes: receiving, by a first client device, data representing a global Internet protocol (IP) address and a local IP address type for a second client device; sending, by the first client device, data representing the global IP address and the local IP address type for the second client device to an intermediate network device between the first client device and the second client device; and receiving, by the first client device, a packet including media data from the second client device via the intermediate network device.

In another example, a first client device for exchanging media data via a network includes: a memory; and a processing system implemented in circuitry and in communication with the memory, the processing system being configured to: receive data representing a global Internet protocol (IP) address and a local IP address type for a second client device; send data representing the global IP address and the local IP address type for the second client device to an intermediate network device between the first client device and the second client device; and receive, by the first client device, a packet including media data from the second client device via the intermediate network device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a flow diagram illustrating an example method of sending, by a user equipment (UE) device engaged in a communication session with another device, local network address information of the other device to a cellular network device.

FIG. 3 is a block diagram illustrating elements of an example video file.

FIG. 4 is a flowchart illustrating an example method of establishing and participating in a media communication session per techniques of this disclosure.

FIG. 5 is a flowchart illustrating an example method of exchanging media data via a network according to techniques of this disclosure.

FIG. 6 is a flowchart illustrating an example method of exchanging media data via a network according to techniques of this disclosure.

FIG. 7 is a flow diagram illustrating an example method of exchanging media data via a network according to techniques of this disclosure.

### DETAILED DESCRIPTION

In general, this disclosure describes techniques for exchanging media data via a network. The network may be a 5G network, a 6G network, or other radio access network (RAN). A protocol data unit (PDU) set represents one or more PDUs each carrying a payload of a unit of information generated at the application level. Thus, for example, a PDU may include a frame of video data, a slice of a frame of video data, audio data, computer graphics data, or other media data for an extended reality (XR) service. 3GPP TS23.501 v.18.1.0 includes this definition of a PDU set.

When two (or more) devices are engaged in an XR session, one device may send a PDU set size to another device, where the PDU set size may represent the total size of all PDUs of the PDU set to which a particular PDU belongs, including RTP/UDP/IP header encapsulation overhead of the corresponding PDUs. An RTP (real-time transport protocol) sender may compute the PDU set size value (PSSize) and include the PSSize value in an RTP header extension of an RTP packet sent to the RTP receiver. However, the IP address version (e.g., IPv4 or IPv6) used by the RTP sender locally to generate the IP packets encapsulating the RTP (and/or, in some cases, UDP (user datagram protocol)) packets may be different from the IP version sent to a user plane function (UPF) device, due to network tunneling (e.g., general packet radio service (GPRS) user data tunneling (GTP-U), IPv4-v6 tunneling, carrier grade network address translation (CGNAT), or network address translation-protocol translation (NAT-PT)). This disclosure recognizes that the UPF (or other intermediate network device) needs to be able to determine the local IP address type to adjust the PSSize, e.g., to ensure that all packets of a PDU set are delivered together.

There are two approaches to resolving the mismatch issue. The first approach is to revise the RTP header extension for PDU Set marking [1] to include the local IP address type. The second approach is to let the AF signal the local IP address type to the UPF. However, in our view, as explained in clause 4, this is a feature/issue that we think we should discuss in Rel-19. These approaches are some of the potential solutions that we are considering discussing in Rel-19. Revising RTP header extension for PDU Set marking.

Therefore, absent the techniques of this disclosure the PSSize value provided by the RTP sender may be inaccurate. That is, absent these techniques, the PSSize may not accurately reflect the size of the PDU set, due to inclusion or exclusion of the local and/or global network address. In RFC 4566 (which specifies the session description protocol (SDP) standard), the address type and the address defined in the “c=” line and the “o=” line are for the global or public address, not the local or private address.

This disclosure describes techniques for exchanging local address information related to a media communication session, e.g., between devices involved in the media communication session or with other intermediate devices, which may use the local address information, e.g., to recalculate the PDU set size value or interpret the PDU set size value.

In particular, per techniques of this disclosure, the local IP address type may be added to the RTP header extension for PDU Set marking. The benefits of doing so may outweigh the potential inefficiency of sending such data in every PDU of a PDU Set. The required number of bits is small: 1 bit (to differentiate between IPv4 and IPv6), and this can be absorbed by another field by shortening the latter by 1 bit. For example, if the number of PDUs is added as a field to the RTP header extension for PDU Set marking in Rel-19, the field may take 16 bits. 16 bits may be still more than enough. The number of bits may be reduced by 1 and the 1 bit may be used for the local IP address type signaling.

SDP signaling as described in RFC 8866 carries the IP address information of the endpoints (i.e., source and destination). The local IP address information is not included in the signaling of RFC 8866. Two attributes, “o=” and “c=,” can carry IP address information (including the network type, the address type, and the connection address) that is necessary to establish a network connection, and hence the information is on the public IP address information when the session traverses a public network. The “o=” attribute also contains address information, including the network type, the address type, and the unicast address. The unicast address may be a fully qualified domain name or an IP address, and it is stated in RFC 8866 that, “the fully qualified domain name is the form that SHOULD be given unless this is unavailable, in which case a globally unique address MAY be substituted.” That is, the address information carried in the “o=” attribute should be public IP address information, although in practice sometimes the private/local IP address information is used instead.

When interactive connectivity establishment (ICE) is used to assist the establishment of an RTP session, the private IP addresses may or may not be exchanged in the SDP signaling. Besides the “o=” attribute and the “c=” attribute, SDP signaling exchanges the candidate transport addresses (each including an IP address and a port number). The “candidate” attribute includes a candidate type (“cand-type”) field, a connection address (“connection-address”) field, a related address (“rel-addr”) field and a related port (“rel-port”) field among other fields. In the case of STUN (cand-type=srflx, or prflx), the related address (“rel-addr”) field carries the private IP address of the STUN client. However, in the case of TURN (i.e., cand-type=relay), the related address (“rel-addr”) field carries the public IP address (i.e., the mapped address in the Allocate response) of the TURN client.

Given the above discussion, the private IP address information may or may not be available with conventional SDP signaling. Thus, per techniques of this disclosure, devices may use an SDP attribute to signal/determine the private IP address type.

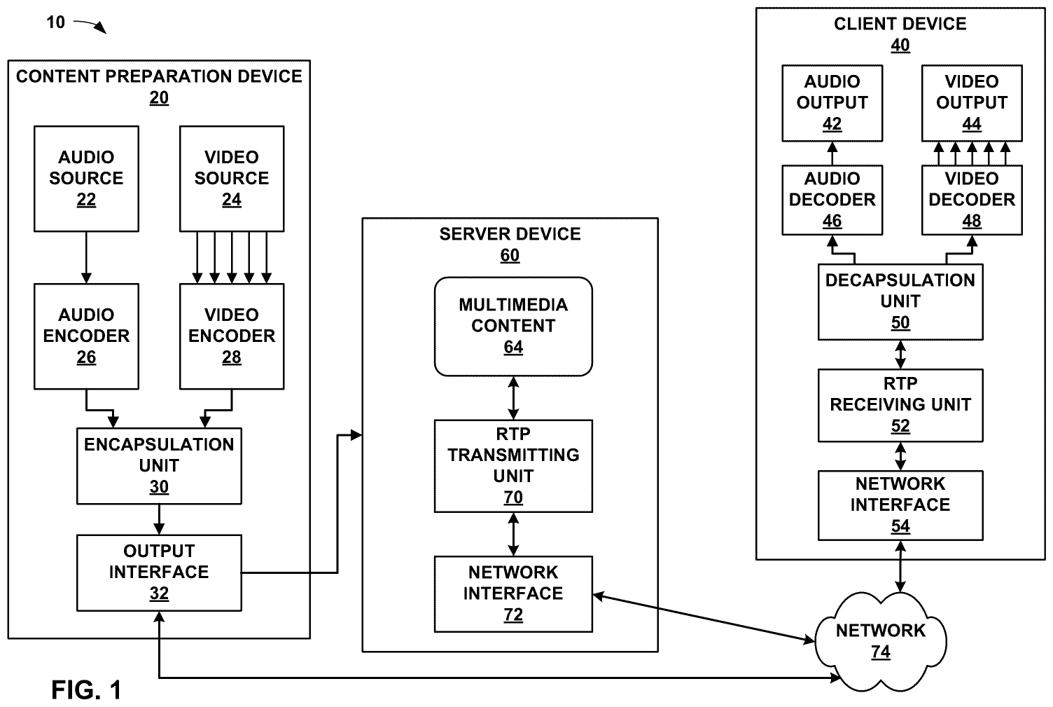

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. In particular, RTP transmitting unit 70 may receive media data such as audio data, video data, extended reality (XR) data, augmented reality (AR) data, mixed reality (MR) data, and/or virtual reality (VR) data. RTP transmitting unit 70 may treat each different type of media data for a particular playback time as a respective protocol data unit (PDU) of a PDU set. When preparing a PDU set for transmission, RTP transmitting unit 70 may encapsulate data of the PDU set into tunneled packets that specify a global network address of server device 60. Thus, when calculating a PDU set size value, which includes a size of IP headers used for encapsulation to tunnel the packets, the PDU set size value may be inaccurate from the perspective of client device 40.

Accordingly, in some examples, server device 60 may send data representing local address information to client device 40. The local address information may include any or all of session information (e.g., a session identifier), a network type for network 74 (e.g., Internet or Ethernet), an address type (e.g., if network 74 is the Internet, whether the address type is IPv4 or IPv6, or if network 74 is an Ethernet network, an indication that the address type is a media access control (MAC) address), and the local network address (e.g., IP address or Ethernet/MAC address) of server device 60.

To send the local address information, server device 60 may send SDP attribute information. For example, server device 60 may send an SDP attribute, which may have the format “a=<attribute>:<value>.” As an example, server device 60 may send “a=localAddr: <sess-id> <nettype> <addrtype> <address>.”<sess-id> may represent a unique identifier of the session, which could be the time when the session was created, e.g., a timestamp in the Network Time Protocol (NTP) format. <nettype> may represent the network type of the local network assumed when server device 60 generates an RTP packet including an RTP header and RTP header extension (e.g., the “PDU set” RTP header extension including the PDU set size value). For example, <nettype> may have a value of “IN” for Internet or “ET” for Ethernet. <addrtype> may represent the type of network address for the local address information, and may depend on the <nettype> value. For example, if <nettype> specifies Internet, <addrtype> may have a value indicating whether the local network address is an IPv4 or an IPv6 address. <address> may specify the actual address of server device 60 in the local network, e.g., a local IP address for the Internet or a MAC address for an Ethernet network.

Alternatively, server device 60 may send such local address information as a line in an SDP message. The line may be an “1=” line, where ‘1’ stands for local. The line may be formatted as “l=<sess-id> <nettype> <addrtype> <address>.” Each of these data elements may be defined as discussed above.

In some examples, server device 60 may specify whether the local address information applies to the entire session or a media stream of the session. For example, if the local address information applies to the entire session, server device 60 may specify the local address information before an “m=” line of an SDP message. Alternatively, if the local address information applies to a media stream of the session, server device 60 may specify the local address information following the “m=” line of the SDP message, such that the local address information applies to the media stream associated with the “m=” line only.

Server device 60 may send the local address information in an SDP Offer message, an SDP Answer message, or both.

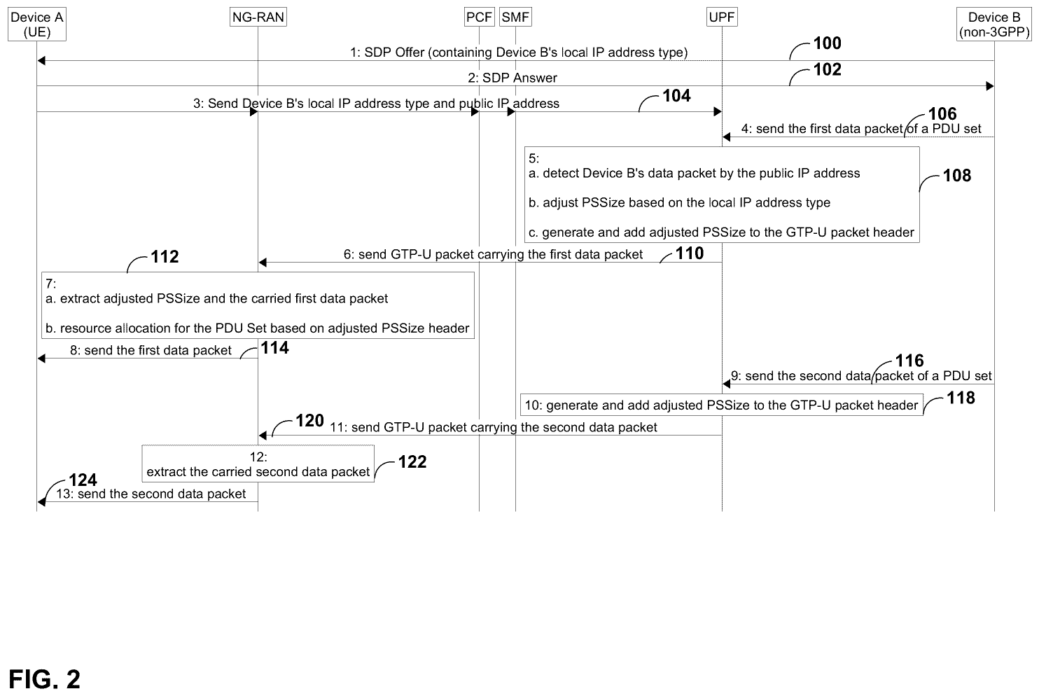

An alternative implementation of techniques of this disclosure is discussed in greater detail below with respect to FIG. 2.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

FIG. 2 is a flow diagram illustrating an example method of sending, by a user equipment (UE) device engaged in a communication session with another device, local network address information of the other device to a cellular network device. In this example, client device 40 of FIG. 1 may correspond to “Device A” of FIG. 2 (that is, a user equipment (UE) device), and server device 60 of FIG. 1 may correspond to “Device B” of FIG. 2 (that is, a non-cellular/3GPP device).

In this example, initially, client device 40 may receive an SDP offer containing the local IP address type of server device 60 (100) from server device 60. Client device 40 may send an SDP answer to server device 60 (102). Alternatively, client device 40 may send the SDP offer to server device 60, and server device 60 may respond with an SDP answer including a global IP address and local IP address type for server device 60. Server device 60 (Device B) may send the local address information to client device 40 (Device A) as discussed above with respect to FIG. 1, e.g., as an SDP attribute or an SDP line of the SDP offer (or answer). In this manner, client device 40 (Device A) and server device 60 (Device B) may establish an RTP session using session description protocol (SDP).

Client device 40 may also send local address information and a public IP address of server device 60 (received in the SDP offer or answer) to a cellular core network (104), e.g., to a device configured to execute a user plane function (UPF) as shown in FIG. 2. Afterwards, the UPF may forward the local IP address type to the session management function (SMF) and the policy and charging function (PCF) in a cascaded fashion.

Subsequently, server device 60 may send a first packet of a PDU set of the RTP session to client device 40 via the UPF (106). According to techniques of this disclosure, the device executing the UPF (or other entity in the cellular core network) may adjust the PSSize for the PDU set sent by server device 60 according to the local IP address type of server device 60 (108). In particular, the UPF may detect that the first packet was sent by server device 60 using a public IP address for server device 60 (e.g., a global IP address of server device 60).

The UPF may further adjust the PDU set size value (PSSize) based on the local IP address type received from client device 40 and add the adjusted PSSize value to a packet header (e.g., RTP extension header or tunneling header, such as a GTP-U (GPRS Tunneling Protocol User Data Tunneling) header) of the packet. When adjusting the PSSize value, the UPF may obtain the IP packet size (“L”) and the IP version (e.g., IPv6) of the DL data packet belonging to the PDU set, find that the IP version from the local address information of server device 60 is IPv4, then adjust PSSize to a new value “Q” according to Q=PSSize*(L+20)/L. The first packet of the PDU set may be used to reduce the latency in adjusting the PSSize value.

The UPF may then send the adjusted packet (e.g., including the value Q as a replacement for the original PSSize value) to client device 40 via a next-generation radio access network (NG-RAN) (110). The packet may be a GTP-U (GPRS Tunneling Protocol User Data Tunneling) packet that carries the DL data packet. A device of the NG-RAN may extract the adjusted PSSize value and the first data packet from the received packet perform resource allocation for the PDU set based on the PSSize value (112). The NG-RAN may then deliver the first data packet to client device 40 over the air (e.g., via a radio access network) (114).

Server device 60 may then send subsequent packets of a separate PDU set to client device 40, and the UPF may adjust the PSSize values for these subsequent packets in similar fashion, as shown in FIG. 2. For example, server device 60 may send a second data packet of a PDU set toward client device 40 (116). The UPF may receive the second data packet and determine that the second data packet originated from server device 60 (Device B) based on the global IP address for server device 60 as was received from client device 40. Thus, the UPF may generate a tunnel header including an adjusted PSSize value for the PDU set (118), which the UPF may calculate based on the local IP address type for server device 60. The UPF may send the tunneled packet toward client device 40 (120). The NG-RAN may extract the second data packet (carried by the tunneled packet) (122) and deliver the second data packet to client device 40 (124).

The cellular core network may be the core network of a 5G network, a 6G network, or other cellular core network. Device B (server device 60) may represent a smart phone connected to the Internet via Wi-Fi, a smart phone connected to a different cellular network, an application server on the Internet, or other such device.

In this manner, the method of FIG. 2 represents an example of a method of exchanging media data via a network, including: receiving, by an intermediate network device (e.g., a device executing a UPF), data from a first client device representing a global Internet protocol (IP) address and a local IP address type for a second client device, the intermediate network device being between the first client device and the second client device; receiving, by the intermediate network device, a packet of a protocol data unit (PDU) set from the second client device destined for the first client device; extracting, by the intermediate network device, a PDU set size (PSSize) value from the packet; forming, by the intermediate network device, an adjusted PSSize value based on the local IP address type for the second client device; adding, by the intermediate network device, the adjusted PSSize value to a tunnel header of a tunneled packet that encapsulates the packet; and sending, by the intermediate network device, the tunneled packet to the first client device.

Likewise, the method of FIG. 2 also represents an example of a method of exchanging media data via a network, including: receiving, by a first client device (e.g., Device A or client device 40 of FIG. 1), data representing a global Internet protocol (IP) address and a local IP address type for a second client device; sending, by the first client device, data representing the global IP address and the local IP address type for the second client device to an intermediate network device between the first client device and the second client device; and receiving, by the first client device, a packet including media data from the second client device via the intermediate network device.

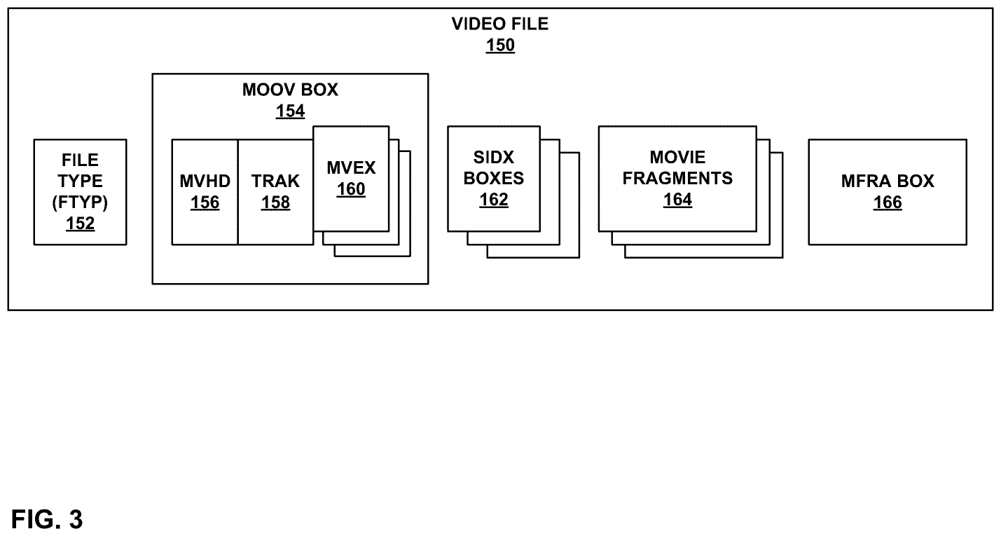

FIG. 3 is a block diagram illustrating elements of an example video file 150. As described above, video files in accordance with the ISO base media file format and extensions thereof store data in a series of objects, referred to as “boxes.” In the example of FIG. 3, video file 150 includes file type (FTYP) box 152, movie (MOOV) box 154, segment index (sidx) boxes 162, movie fragment (MOOF) boxes 164, and movie fragment random access (MFRA) box 166. Although FIG. 3 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 3, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 3). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

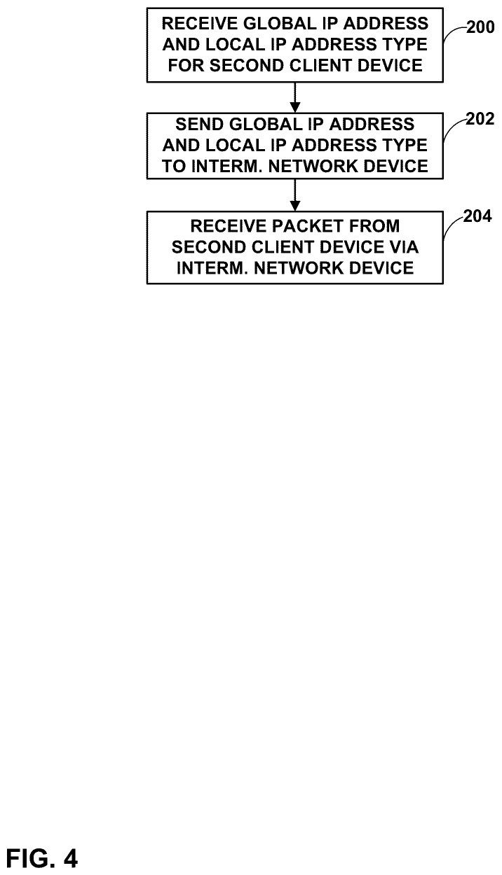

FIG. 4 is a flowchart illustrating an example method of establishing and participating in a media communication session per techniques of this disclosure. The method of FIG. 4 may be performed by a client device, such as a user equipment (UE) device.

Initially, the client device may obtain data representing a global Internet protocol (IP) address and a local IP address type of a second client device (200). For example, the client device may receive an SDP Offer or Answer message including this data. Additionally or alternatively, the client device may receive an RTP header including an RTP header extension including this data. The local IP address type may be, for example, IPv4 or IPv6. As discussed above, the global IP address and local IP address type may be specified for the entire communication session, or only to a particular stream of the communication session.

The client device may then send data representing the global IP address and the local IP address type to an intermediate network device (202).

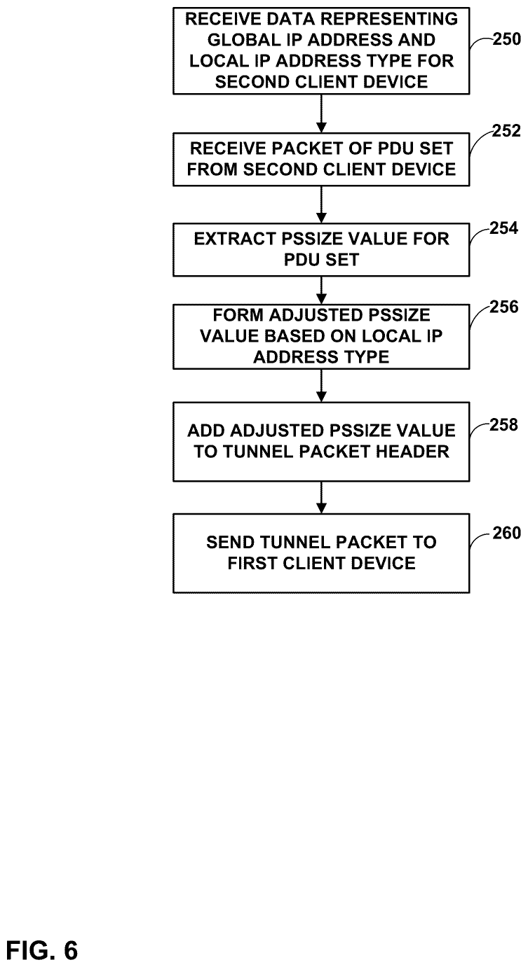

As discussed with respect to FIG. 2 and FIG. 6 in greater detail below, the intermediate network device may use the global IP address of the second client device to identify packets received from the second client device. For example, such packets may be data packets of a media communication session between the client device and the second client device. The intermediate network device may forward such data packets to the client device via a network tunnel, e.g., a GTP-U tunnel. Accordingly, the intermediate network device may encapsulate the data packet in a GTP-U packet, and add a recalculated PSSize value (based on a local IP address type for the second client device) to a GTP-U packet header to indicate an overall size of a PDU set to which the data packet corresponds. These packets may then be received by a local NG-RAN, which may send the packets to the local client device. Accordingly, the client device may then receive the packet from the second client device via the intermediate network device (204).

In this manner, the method of FIG. 4 represents an example of a method of exchanging media data via a network, including: receiving, by a first client device, data representing a global Internet protocol (IP) address and a local IP address type for a second client device; sending, by the first client device, data representing the global IP address and the local IP address type for the second client device to an intermediate network device between the first client device and the second client device; and receiving, by the first client device, a packet including media data from the second client device via the intermediate network device.

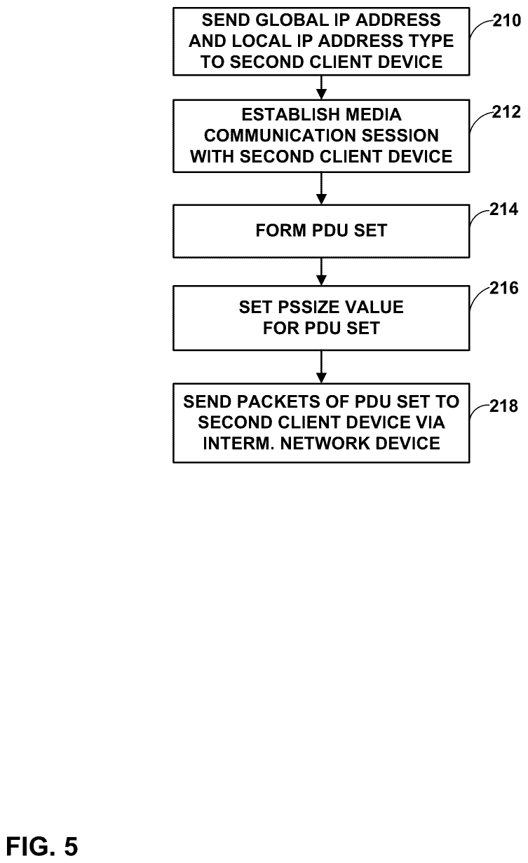

FIG. 5 is a flowchart illustrating an example method of exchanging media data via a network according to techniques of this disclosure. The method of FIG. 5 may be performed by a client device, such as a user equipment (UE) device, that is external to a radio access network (RAN) of second client device with which the client device is engaging in a media communication session.

Initially, the client device may send its global IP address and a local IP address type to the second client device (210). As discussed above, for example, the client device may add this data to a RTP extension header of an RTP packet sent to the second client device. Additionally or alternatively, the client device may add this information to an SDP offer or SDP answer. Ultimately, the client device and the second client device may establish a media communication session (212).

The client device may then form a PDU set (214). The PDU say may include PDUs, each including media data for the media communication session. In general, the media data of the PDUs of the PDU set may be expected to be presented together. For example, the PDU set may represent a set of audio data, video data, image data, computer generated graphics data, or the like, that is all expected to be presented simultaneously.

As such, the client device may set a PSSize value for the PDU set (216), indicating the amount of data included in the PDU set. The client device may send packets of the PDU set to the second client device via an intermediate network device (218). Per the techniques of this disclosure, the intermediate network device may be configured to calculate an adjusted PSSize value for the PDU set based on the local IP address type (e.g., IPv4 or IPv6) of the client device, as discussed in greater detail with respect to FIG. 6 below.

FIG. 6 is a flowchart illustrating an example method of exchanging media data via a network according to techniques of this disclosure. The method of FIG. 6 may be performed by an intermediate network device, such as a device that executes a user plane function (UPF).

Initially, the intermediate network device may receive data from a first client device that represents a global IP address and a local IP address type for a second client device (250). In this case, the first client device and the second client device establish a media communication session that flows through the intermediate network device. The first client device may be communicatively coupled to a radio access network (RAN) associated with a service provider that includes the intermediate network device, where the intermediate network device may execute a user plane function (UPF) for the service provider and the RAN.

The intermediate network device may store the global IP address to identify packets received from the second client device, and use the local IP address type of the second client device to calculate an updated PSSize value for packets received from the second client device that are to be sent via a network tunnel to the first client device. Thus, the intermediate network device may receive a packet of a PDU set from the second client device (252). The intermediate network device may identify the packet as originating from the second client device using the global IP address of the second client device. The intermediate network device may extract the PSSize value for the PDU set as indicated in the packet (254), and calculate an adjusted PSSize value based on the local IP address type (256) for the second client device. It is assumed, in this example, that the local IP address type for which the original PSSize value for the PDU set as calculated by the second client device differs from the public IP address type. In cases where these IP address types are the same, no adjustment need be performed. Instead, the PSSize value advertised in the received packet may be used for the tunneled packet.

The intermediate network device may add the adjusted PSSize value to a tunnel packet header (258) of a tunnel packet encapsulating the received packet. For example, the intermediate network device may encapsulate the received packet into a tunneled (e.g., GTP-U) packet with a tunnel packet header. The intermediate network device may add the adjusted PSSize value to the tunnel packet header. The intermediate network device may then send the tunnel packet to the first client device (260).

In this manner, the method of FIG. 6 represents an example of a method of exchanging media data via a network, including: representing a global Internet protocol (IP) address and a local IP address type for a second client device, the intermediate network device being between the first client device and the second client device; receiving, by the intermediate network device, a packet of a protocol data unit (PDU) set from the second client device destined for the first client device; extracting, by the intermediate network device, a PDU set size (PSSize) value from the packet; forming, by the intermediate network device, an adjusted PSSize value based on the local IP address type for the second client device; adding, by the intermediate network device, the adjusted PSSize value to a tunnel header of a tunneled packet that encapsulates the packet; and sending, by the intermediate network device, the tunneled packet to the first client device.

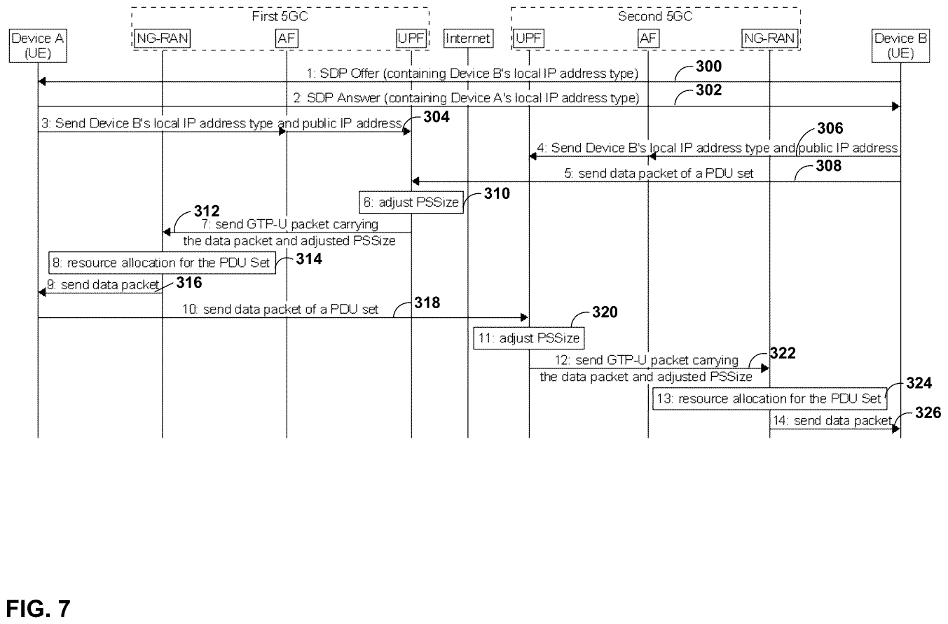

FIG. 7 is a flow diagram illustrating an example method of exchanging media data via a network according to techniques of this disclosure. In this example, two client devices (Device A and Device B) are each connected to respective, separate radio access networks (RANs). Each of the RANs is associated with separate, respective UPF devices (i.e., devices that execute a UPF for the respective RAN). Devices A and B may each include functional components similar to those of server device 60 and client device 40 of FIG. 1. For example, each of Devices A and B may be respective user equipment (UE) devices.

In this example, Device B sends an SDP offer including the global IP address and local IP address type for Device B to Device A (300). In response, Device A sends an SDP answer including the global IP address and local IP address for Device A to Device B. Device A also sends the global (public) IP address and the local IP address type to the UPF associated with the RAN to which Device A is coupled (304), while Device B also sends the global IP address and local IP address type to the UPF associated with the RAN to which Device B is coupled (306).

In this example, Device B sends a data packet of a PDU set to Device A (308). The UPF associated with the RAN to which Device A is coupled receives the data packet from Device B (as determined by the packet including the global IP address of Device B, e.g., as a source IP address in a network 5-tuple of a header of the packet). In response, the UPF adjusts a PSSize value based on the local IP address type for Device B (310). The UPF also adds the adjusted PSSize value to a tunnel header used to encapsulate the packet (e.g., forming a GTP-U tunnel packet). The UPF sends the tunnel packet to the RAN to which Device A is coupled (312). The NG-RAN then performs resource allocation for the PDU set associated with the packet (314) and delivers the data packet to Device A.

Likewise, Device A sends a data packet of a separate PDU set to the UPF associated with the RAN to which Device B is communicatively coupled (318). The UPF of the RAN to which Device B is communicatively coupled receives the packet and adjusts a PSSize value for the PDU set based on the local IP address associated with Device A (320). The UPF then forms a tunneled packet (e.g., a GTP-U packet) including a tunnel header having the adjusted PSSize value, and sends the tunneled packet to the RAN to which Device B is coupled (322). The RAN performs resource allocation for the PDU set to be received from Device A using the PSSize value (324) and delivers the data packet to Device B (326).

In this manner, the method of FIG. 7 represents an example of a method of exchanging media data via a network, including: receiving, by an intermediate network device (e.g., a device executing a UPF), data from a first client device representing a global Internet protocol (IP) address and a local IP address type for a second client device, the intermediate network device being between the first client device and the second client device; receiving, by the intermediate network device, a packet of a protocol data unit (PDU) set from the second client device destined for the first client device; extracting, by the intermediate network device, a PDU set size (PSSize) value from the packet; forming, by the intermediate network device, an adjusted PSSize value based on the local IP address type for the second client device; adding, by the intermediate network device, the adjusted PSSize value to a tunnel header of a tunneled packet that encapsulates the packet; and sending, by the intermediate network device, the tunneled packet to the first client device.

Likewise, the method of FIG. 7 also represents an example of a method of exchanging media data via a network, including: receiving, by a first client device (e.g., Device A or client device 40 of FIG. 1), data representing a global Internet protocol (IP) address and a local IP address type for a second client device; sending, by the first client device, data representing the global IP address and the local IP address type for the second client device to an intermediate network device between the first client device and the second client device; and receiving, by the first client device, a packet including media data from the second client device via the intermediate network device.

The following clauses summarize various examples of the techniques of this disclosure:

Clause 1: A method of exchanging media data via a network, the method comprising: establishing, by a first network device, a media communication session with a second network device; generating, by a first network device, a protocol data unit (PDU) set including one or more PDUs, the PDU set being associated with a local network address for the first network device; encapsulating, by the first network device, data of the PDU set into one or more packets specifying a global network address for the first network device, the global network address being different than the local network address, wherein encapsulating the data includes adding a PDU set size value representing a total size of all PDUs of the PDU set to which PDUs of the one or more packets belong and the PDU set size value being based on the global network address; and sending, by the first network device, the one or more packets to the second network device via a user plane function (UPF).

Clause 2: The method of clause 1, further comprising sending, by the first network device, local address information to the second network device.

Clause 3: The method of clause 2, wherein the local address information includes session information for the media communication session between the first network device and the second network device.

Clause 4: The method of clause 3, wherein the session information comprises a session identifier.

Clause 5: The method of any of clauses 2-4, wherein the local address information includes a network type for a network connecting the first network device and the second network device.

Clause 6: The method of clause 5, wherein the network type comprises one of Internet or Ethernet.

Clause 7: The method of any of clauses 2-6, wherein the local address information includes an address type for the local network address.

Clause 8: The method of clause 7, wherein the local network address comprises an IP address, and wherein the address type specifies whether the IP address is an IPv4 address or an IPv6 address.

Clause 9: The method of any of clauses 2-8, wherein the local address information includes the local network address.

Clause 10: The method of clause 9, wherein the local network address comprises one of a local IP address, an Ethernet address, or a media access control (MAC) address.

Clause 11: The method of any of clauses 2-10, wherein sending the local address information comprises sending one or more session description protocol (SDP) attributes representing the local address information, each of the SDP attributes being in the format “a=<attribute>:<value>.”

Clause 12: The method of clause 11, wherein sending the local address information includes sending an SDP attribute specifying each of a session identifier, a network type, an address type, and the local network address.

Clause 13: The method of any of clauses 11 and 12, wherein sending the local address information includes sending an SDP attribute of the form “a=localAddr: <sess-id> <nettype> <addrtype> <address>,” wherein <sess-id> represents a unique identifier for a session between the first network device and the second network device, <nettype> represents a network type for a network connecting the first network device and the second network device, <addrtype> represents a type of network address for the local network address, and <address> represents the local network address.

Clause 14: The method of any of clauses 2-10, wherein sending the local address information comprises sending a line in a session description protocol (SDP) message.

Clause 15: The method of clause 14, wherein the line in the SDP message is in the form of “l=<sess-id> <nettype> <addrtype> <address>,” wherein <sess-id> represents a unique identifier for a session between the first network device and the second network device, <nettype> represents a network type for a network connecting the first network device and the second network device, <addrtype> represents a type of network address for the local network address, and <address> represents the local network address.

Clause 16: The method of any of clauses 2-15, further comprising determining whether the local address information applies to an entire session or a media stream of the session, and: when the local address information applies to the entire session, providing the local address information before an “m=” line of a session description protocol (SDP) message; or when the local address information applies to a media stream of the session, providing the local address information after the “m=” line of the SDP message.

Clause 17: The method of any of clauses 2-16, wherein sending the local address information comprises sending the local address information in at least one of a session description protocol (SDP) Offer message or an SDP Answer message.

Clause 18: The method of any of clauses 1-17, wherein generating the PDU set includes generating one or more user datagram protocol (UDP) packets or one or more real-time transport protocol (RTP) packets.

Clause 19: The method of any of clauses 1-18, further comprising sending, by the first network device, a local network address for the second network device to a cellular network device.

Clause 20: The method of clause 19, wherein the cellular network device comprises a device that provides a cellular network Application Function (AF).

Clause 21: The method of any of clauses 19 and 20, further comprising receiving, via the UPF, a data packet of a PDU set originating from the second network device.

Clause 22: A first network device for exchanging media data via a network, the first network device comprising a processing system including one or more processors implemented in circuitry, the processing system being configured to perform the method of any of clauses 1-21.

Clause 23: The first network device of clause 22, further comprising a memory configured to store data of the PDU set.

Clause 24: A computer-readable storage medium having stored thereon instructions that, when executed, cause a processing system of a first network device to perform the method of any of clauses 1-21.

Clause 25: A first network device for exchanging media data via a network, the first network device comprising: means for establishing a media communication session with a second network device; means for generating a protocol data unit (PDU) set including one or more PDUs, the PDU set being associated with a local network address for the second network device; means for encapsulating data of the PDU set into one or more packets specifying a global network address for the first network device, the global network address being different than the local network address, wherein encapsulating the data includes adding a PDU set size value representing a total size of all PDUs of the PDU set to which PDUs of the one or more packets belong and the PDU set size value being based on the global network address; and means for sending the one or more packets to the second network device via a user plane function (UPF).

Clause 26: A method of exchanging media data via a network, the method comprising: receiving, by an intermediate network device, data from a first client device representing a global Internet protocol (IP) address and a local IP address type for a second client device, the intermediate network device being between the first client device and the second client device; receiving, by the intermediate network device, a packet of a protocol data unit (PDU) set from the second client device destined for the first client device; extracting, by the intermediate network device, a PDU set size (PSSize) value from the packet; forming, by the intermediate network device, an adjusted PSSize value based on the local IP address type for the second client device; adding, by the intermediate network device, the adjusted PSSize value to a tunnel header of a tunneled packet that encapsulates the packet; and sending, by the intermediate network device, the tunneled packet to the first client device.

Clause 27: The method of clause 26, wherein the local IP address type comprises one of IPv4 or IPv6.

Clause 28: The method of clause 26, wherein the tunneled packet comprises a general packet radio service (GPRS) user data tunneling (GTP-U) packet, and wherein the tunnel header comprises a GTP-U header of the GTP-U packet.

Clause 29: A network device for exchanging media data via a network, the network device comprising: a memory; and a processing system implemented in circuitry and in communication with the memory, the processing system being configured to: receive data from a first client device representing a global Internet protocol (IP) address and a local IP address type for a second client device, the network device being between the first client device and the second client device; receive a packet of a protocol data unit (PDU) set from the second client device destined for the first client device; extract a PDU set size (PSSize) value from the packet; form an adjusted PSSize value based on the local IP address type for the second client device; add the adjusted PSSize value to a tunnel header of a tunneled packet that encapsulates the packet; and send the tunneled packet to the first client device.

Clause 30: The network device of clause 29, wherein the local IP address type comprises one of IPv4 or IPv6.

Clause 31: The network device of clause 29, wherein the tunneled packet comprises a general packet radio service (GPRS) user data tunneling (GTP-U) packet, and wherein the tunnel header comprises a GTP-U header of the GTP-U packet.

Clause 32: A method of exchanging media data via a network, the method comprising: receiving, by a first client device, data representing a global Internet protocol (IP) address and a local IP address type for a second client device; sending, by the first client device, data representing the global IP address and the local IP address type for the second client device to an intermediate network device between the first client device and the second client device; and receiving, by the first client device, a packet including media data from the second client device via the intermediate network device.

Clause 33: The method of clause 32, wherein the local IP address type comprises one of IPv4 or IPv6.

Clause 34: The method of clause 32, wherein the data representing the local IP address type includes session information for a media communication session between the first client device and the second client device.

Clause 35: The method of clause 34, wherein the session information comprises a session identifier.

Clause 36: The method of clause 32, wherein the data representing the local IP address type includes a network type for a network connecting the first client device and the second client device.

Clause 37: The method of clause 36, wherein the network type comprises one of Internet or Ethernet.

Clause 38: The method of clause 32, wherein the data representing the local IP address type further includes at least one of an Ethernet address or a media access control (MAC) address for the second client device.

Clause 39: The method of clause 32, wherein receiving the data representing the local IP address type comprises receiving one or more session description protocol (SDP) attributes representing the local IP address type, each of the SDP attributes being in the format “a=<attribute>:<value>.”

Clause 40: The method of clause 32, wherein receiving the data representing the local IP address type includes receiving an SDP attribute specifying each of a session identifier, a network type, the local IP address type, and a local IP address.

Clause 41: The method of clause 40, wherein receiving the data representing the local IP address type includes receiving an SDP attribute of the form “a=localAddr: <sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

Clause 42: The method of clause 32, wherein receiving the data representing the local IP address type comprises receiving a line of a session description protocol (SDP) message, wherein the line of the SDP message is in the form of “l=<sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

Clause 43: The method of clause 32, further comprising determining whether the local IP address type applies to an entire session or a media stream of the session, including: when the local IP address type is specified before an “m=” line of a session description protocol (SDP) message, determining that the local IP address type applies to the entire session; or when the local IP address type is specified after the “m=” line of the SDP message, determining that the local IP address type applies to the media stream of the session.

Clause 44: The method of clause 32, wherein receiving the data representing the local IP address type comprises receiving the data representing the local IP address type in at least one of a session description protocol (SDP) Offer message or an SDP Answer message.

Clause 45: The method of clause 32, wherein the intermediate network device comprises a device that provides a cellular network Application Function (AF).

Clause 46: A first client device for exchanging media data via a network, the first client device comprising: a memory; and a processing system implemented in circuitry and in communication with the memory, the processing system being configured to: receive data representing a global Internet protocol (IP) address and a local IP address type for a second client device; send data representing the global IP address and the local IP address type for the second client device to an intermediate network device between the first client device and the second client device; and receive, by the first client device, a packet including media data from the second client device via the intermediate network device.

Clause 47: The first client device of clause 46, wherein the local IP address type comprises one of IPv4 or IPv6.

Clause 48: The first client device of clause 46, wherein the data representing the local IP address type further includes at least one of an Ethernet address or a media access control (MAC) address for the second client device.

Clause 49: The first client device of clause 46, wherein to receive the data representing the local IP address type, the processing system is configured to receive one or more session description protocol (SDP) attributes representing the local IP address type, each of the SDP attributes being in the format “a=<attribute>:<value>.”

Clause 50: The first client device of clause 46, wherein to receive the data representing the local IP address type, the processing system is configured to receive an SDP attribute specifying each of a session identifier, a network type, the local IP address type, and a local IP address.

Clause 51: The first client device of clause 50, wherein to receive the data representing the local IP address type, the processing system is configured to receive an SDP attribute of the form “a=localAddr: <sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

Clause 52: The first client device of clause 46, wherein to receive the data representing the local IP address type, the processing system is configured to receive a line of a session description protocol (SDP) message, wherein the line of the SDP message is in the form of “1=<sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

Clause 53: The first client device of clause 46, wherein the processing system is further configured to determine whether the local IP address type applies to an entire session or a media stream of the session, including: when the local IP address type is specified before an “m=” line of a session description protocol (SDP) message, determine that the local IP address type applies to the entire session; or when the local IP address type is specified after the “m=” line of the SDP message, determine that the local IP address type applies to the media stream of the session.

Clause 54: The first client device of clause 46, wherein to receive the data representing the local IP address type, the processing system is configured to receive the data representing the local IP address type in at least one of a session description protocol (SDP) Offer message or an SDP Answer message.

Clause 55: The first client device of clause 46, wherein the intermediate network device comprises a device that provides a cellular network Application Function (AF).

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of exchanging media data via a network, the method comprising:
receiving, by an intermediate network device, data from a first client device representing a global Internet protocol (IP) address and a local IP address type for a second client device, the intermediate network device being between the first client device and the second client device;
receiving, by the intermediate network device, a packet of a protocol data unit (PDU) set from the second client device destined for the first client device;
extracting, by the intermediate network device, a PDU set size (PSSize) value from the packet;
forming, by the intermediate network device, an adjusted PSSize value based on the local IP address type for the second client device;
adding, by the intermediate network device, the adjusted PSSize value to a tunnel header of a tunneled packet that encapsulates the packet; and
sending, by the intermediate network device, the tunneled packet to the first client device.

2. The method of claim 1, wherein the local IP address type comprises one of IPv4 or IPv6.

3. The method of claim 1, wherein the tunneled packet comprises a general packet radio service (GPRS) user data tunneling (GTP-U) packet, and wherein the tunnel header comprises a GTP-U header of the GTP-U packet.

4. A network device for exchanging media data via a network, the network device comprising:
a memory; and
a processing system implemented in circuitry and in communication with the memory, the processing system being configured to:
receive data from a first client device representing a global Internet protocol (IP) address and a local IP address type for a second client device, the network device being between the first client device and the second client device;
receive a packet of a protocol data unit (PDU) set from the second client device destined for the first client device;
extract a PDU set size (PSSize) value from the packet;
form an adjusted PSSize value based on the local IP address type for the second client device;
add the adjusted PSSize value to a tunnel header of a tunneled packet that encapsulates the packet; and
send the tunneled packet to the first client device.

5. The network device of claim 4, wherein the local IP address type comprises one of IPv4 or IPv6.

6. The network device of claim 4, wherein the tunneled packet comprises a general packet radio service (GPRS) user data tunneling (GTP-U) packet, and wherein the tunnel header comprises a GTP-U header of the GTP-U packet.

7. A method of exchanging media data via a network, the method comprising:
receiving, by a first client device, data representing a global Internet protocol (IP) address and a local IP address type for a second client device;
sending, by the first client device, data representing the global IP address and the local IP address type for the second client device to an intermediate network device between the first client device and the second client device; and
receiving, by the first client device, a packet including media data from the second client device via the intermediate network device.

8. The method of claim 7, wherein the local IP address type comprises one of IPv4 or IPv6.

9. The method of claim 7, wherein the data representing the local IP address type includes session information for a media communication session between the first client device and the second client device.

10. The method of claim 9, wherein the session information comprises a session identifier.

11. The method of claim 7, wherein the data representing the local IP address type includes a network type for a network connecting the first client device and the second client device.

12. The method of claim 11, wherein the network type comprises one of Internet or Ethernet.

13. The method of claim 7, wherein the data representing the local IP address type further includes at least one of an Ethernet address or a media access control (MAC) address for the second client device.

14. The method of claim 7, wherein receiving the data representing the local IP address type comprises receiving one or more session description protocol (SDP) attributes representing the local IP address type, each of the SDP attributes being in the format “a=<attribute>:<value>.”

15. The method of claim 7, wherein receiving the data representing the local IP address type includes receiving an SDP attribute specifying each of a session identifier, a network type, the local IP address type, and a local IP address.

16. The method of claim 15, wherein receiving the data representing the local IP address type includes receiving an SDP attribute of the form “a=localAddr: <sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

17. The method of claim 7, wherein receiving the data representing the local IP address type comprises receiving a line of a session description protocol (SDP) message, wherein the line of the SDP message is in the form of “1=<sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

18. The method of claim 7, further comprising determining whether the local IP address type applies to an entire session or a media stream of the session, including:
when the local IP address type is specified before an “m=” line of a session description protocol (SDP) message, determining that the local IP address type applies to the entire session; or
when the local IP address type is specified after the “m=” line of the SDP message, determining that the local IP address type applies to the media stream of the session.

19. The method of claim 7, wherein receiving the data representing the local IP address type comprises receiving the data representing the local IP address type in at least one of a session description protocol (SDP) Offer message or an SDP Answer message.

20. The method of claim 7, wherein the intermediate network device comprises a device that provides a cellular network Application Function (AF).

21. A first client device for exchanging media data via a network, the first client device comprising:
a memory; and
a processing system implemented in circuitry and in communication with the memory, the processing system being configured to:
receive data representing a global Internet protocol (IP) address and a local IP address type for a second client device;
send data representing the global IP address and the local IP address type for the second client device to an intermediate network device between the first client device and the second client device; and
receive, by the first client device, a packet including media data from the second client device via the intermediate network device.

22. The first client device of claim 21, wherein the local IP address type comprises one of IPv4 or IPv6.

23. The first client device of claim 21, wherein the data representing the local IP address type further includes at least one of an Ethernet address or a media access control (MAC) address for the second client device.

24. The first client device of claim 21, wherein to receive the data representing the local IP address type, the processing system is configured to receive one or more session description protocol (SDP) attributes representing the local IP address type, each of the SDP attributes being in the format “a=<attribute>:<value>.”

25. The first client device of claim 21, wherein to receive the data representing the local IP address type, the processing system is configured to receive an SDP attribute specifying each of a session identifier, a network type, the local IP address type, and a local IP address.

26. The first client device of claim 25, wherein to receive the data representing the local IP address type, the processing system is configured to receive an SDP attribute of the form “a=localAddr: <sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

27. The first client device of claim 21, wherein to receive the data representing the local IP address type, the processing system is configured to receive a line of a session description protocol (SDP) message, wherein the line of the SDP message is in the form of “1=<sess-id> <nettype> <addrtype> <address>,” wherein <sess-id> represents a unique identifier for a session between the first client device and the second client device, <nettype> represents a network type for a network connecting the first client device and the second client device, <addrtype> represents the local IP address type, and <address> represents a local IP address.

28. The first client device of claim 21, wherein the processing system is further configured to determine whether the local IP address type applies to an entire session or a media stream of the session, including:
when the local IP address type is specified before an “m=” line of a session description protocol (SDP) message, determine that the local IP address type applies to the entire session; or
when the local IP address type is specified after the “m=” line of the SDP message, determine that the local IP address type applies to the media stream of the session.

29. The first client device of claim 21, wherein to receive the data representing the local IP address type, the processing system is configured to receive the data representing the local IP address type in at least one of a session description protocol (SDP) Offer message or an SDP Answer message.

30. The first client device of claim 21, wherein the intermediate network device comprises a device that provides a cellular network Application Function (AF).
